(19) United States
(12) Patent Application Publication
(10) Pub. No.: US 2012/0113828 A1
(43) Pub. Date: May 10, 2012

(54) BEAM-FORMER HUB

(76) Inventors: Thomas Williston Head, Chantilly, VA (US); Chintan Patel, Sterling, VA (US); Richard Cuthill, Reston, VA (US)

(21) Appl. No.: 12/942,267

(22) Filed: Nov. 9, 2010

(51) Int. Cl. H04W 24/00

(52) U.S. Cl. 370/252

(57) ABSTRACT

A method, program, system and apparatus for implementing programmable radio patterns (i.e. beam-forming) in a wireless communication network are discussed. Beam-forming is performed by weighting data samples to compensate for phase variation and frequency variation introduced by a signal path. The phase variation and frequency variation introduced by a signal path is estimated by correlating stored data and calibration data. The phase variation and frequency variation are compensated for by applying phase and frequency corrections, or weights, to the data so as to equalize the phase variation and t frequency variation of the data.

### BACKGROUND OF THE INVENTION

1. Field of the Invention

The present invention generally relates to beam-forming in a wireless communication network. In particular, the present invention relates to using standard remote radio head (RRH) equipment and a digitally controlled antenna array to form programmable radio patterns (i.e., beam-forming).

2. Description of the Related Art

FIG. 1 shows the conventional architecture of a 2×2 Multiple Input Multiple Output (MIMO) remote radio head (RRH) 7 in a wireless communication system. Specifically, in FIG. 1 the connectivity between two base stations 1 and a P-channel RRH 7 (where P=2), supporting 2×2 Multiple Input Multiple Output (MIMO) technology, is shown. Each base station 1 has a bandwidth of N MHz and is connected to the RRH 7 via a fiber interface 2. The fiber interface 2 typically used for this link is specified by, for example, the Open Base Station Architecture Initiative (OBSAI), or the Common Protocol Radio Interface (CPRI). In addition, any other propriety digital interface could be used as the fiber interface 2 shown in FIG. 1.

In the downlink (DL) direction, data is transmitted from the base stations 1 to the fiber interfaces 2. The data is then extracted from both of the fiber interfaces 2 and digitally combined. Next, the data is up-converted and sent to one of the two antennas 8, depending on which of the two signal processing paths is used. Each of the signal processing paths shown in FIG. 1 has a 2N MHz bandwidth. Thus, each antenna 8 is driven by a signal having a bandwidth equal to 2N MHz, where N is equal to the bandwidth of each of the base stations 1.

Similarly, in the uplink (UL) direction, each antenna 8 receives a 2N MHz signal which is then down-converted. The signal is tuned, split into N MHz signals, and then transmitted to the base stations 1. The signal processing path of each of the MIMO branches is the same.

Beam-forming is a signal processing technique used to control the directionality of the reception or transmission of a signal on an antenna array. By using beam-forming, the majority of a signal's energy can be transmitted by the antenna array in a chosen angular direction. In general, the higher the number of antennas in an antenna array, the higher the directionality of the radio energy. In other words, a larger number of antennas in an antenna array allows for narrower radio beams. An important aspect of successful beam-forming is the ability to match the characteristics of the individual signal processing paths to each other within pre-specified tolerances. One advantage of the beam-former hub and beam-forming method of the present application is the ability to these characteristics of the individual signal processing paths within pre-specified tolerances. Several embodiments of a novel beam-forming method and beam-former hub are discussed below.

### SUMMARY OF THE INVENTION

An embodiment of the invention is directed to a method for performing beam-forming in a wireless communication network. The method includes receiving data having a particular data protocol; storing the received data by terminating the particular data protocol, extracting data samples, and storing relevant control fields; obtaining calibration data for a signal path; estimating a phase variation and a frequency variation introduced by the signal path by correlating the stored data and the calibration data; determining a weight based on the estimated phase variation and the estimated frequency variation; weighting the extracted data samples using the determined weight; re-encapsulating the weighted data samples using the particular data protocol to create weighted data; and transmitting the weighted data using the stored control fields so that the phase variation and the frequency variation are equalized.

An embodiment of the invention is directed to a program recorded on a computer-readable recording medium for performing beam-forming in a wireless communication network. This program causes a computer to execute the beam-forming steps that include receiving data having a particular data protocol; storing received data received by terminating the particular data protocol of the received data, extracting data samples from the received data, and storing control fields of the received data; receiving calibration data; determining a weight by estimating a phase variation and a frequency variation, introduced by a signal path, by correlating the stored data and the calibration data; weighting the extracted data samples using the determined weight; re-encapsulating the weighted data samples using the particular data protocol to create weighted data; and transmitting the weighted data using the stored control fields.

An embodiment of the invention is directed to an apparatus for performing beam-forming in a wireless communication network. The apparatus includes a plurality of interfaces for transmitting and receiving data having a particular data protocol; a calibration unit for controlling the switch to transmit calibration data for a particular signal path, receiving, from the antenna array, calibration data for the particular signal path, and correlating the calibration data with the data to obtain correlation data; and a beam-forming unit for performing beam-forming by applying a weight to the data based on the correlation to create weighted data.

An embodiment of the invention is directed to a system for performing beam-forming in a wireless communication network. The system includes a plurality of base stations for transmitting and receiving data; a plurality of remote radio heads for transmitting and receiving data; an antenna array including a switch for transmitting calibration data; and a beam-former hub apparatus for performing beam-forming.

### BRIEF DESCRIPTION OF THE DRAWINGS

In the drawings, like reference numbers generally indicate identical, functionally similar, and/or structurally similar elements. Embodiments of the invention will be described with reference to the accompanying drawings, wherein:

FIG. 1 illustrates a conventional wireless communication system;

FIG. 2 illustrates a system implementing the beam-former hub and beam-former antenna array in a wireless communication network, in accordance with an embodiment of the invention;

FIG. 3 illustrates a system implementing the beam-former hub and beam-former antenna array in a wireless communication network, in accordance with an embodiment of the invention;

FIG. 4 illustrates a system implementing the beam-former hub and beam-former antenna array in a wireless communication network, in accordance with an embodiment of the invention.

FIG. 5 illustrates the components of a beam-former hub and a beam-former antenna array, in accordance with an embodiment of the invention;

FIG. 6 illustrates a flowchart showing a method of beam-forming in downlink data transmission, in accordance with an embodiment of the invention;

FIG. 7 illustrates the components of a beam-former hub and a beam-former antenna array, in accordance with an embodiment of the invention;

FIG. 8 illustrates a flowchart showing a method of beam-forming in uplink data transmission, in accordance with an embodiment of the invention;

FIG. 9 illustrates a beam-former hub apparatus in accordance with an embodiment of the invention.

Additional features are described herein, and will be apparent from the following description of the figures.

### DETAILED DESCRIPTION OF THE INVENTION

In the description that follows, numerous details are set forth in order to provide a thorough understanding of the invention. It will be appreciated by those skilled in the art that variations of these specific details are possible, while still achieving the results of the invention. Well-known elements and processing steps are generally not described in detail in order to avoid unnecessarily obscuring the description of the invention.

In the drawings accompanying the description that follows, often both reference numerals and legends (labels, text descriptions) may be used to identify elements. If legends are provided, they are intended merely as an aid to the reader, and should not in any way be interpreted as limiting.

Beam-Former Hub:

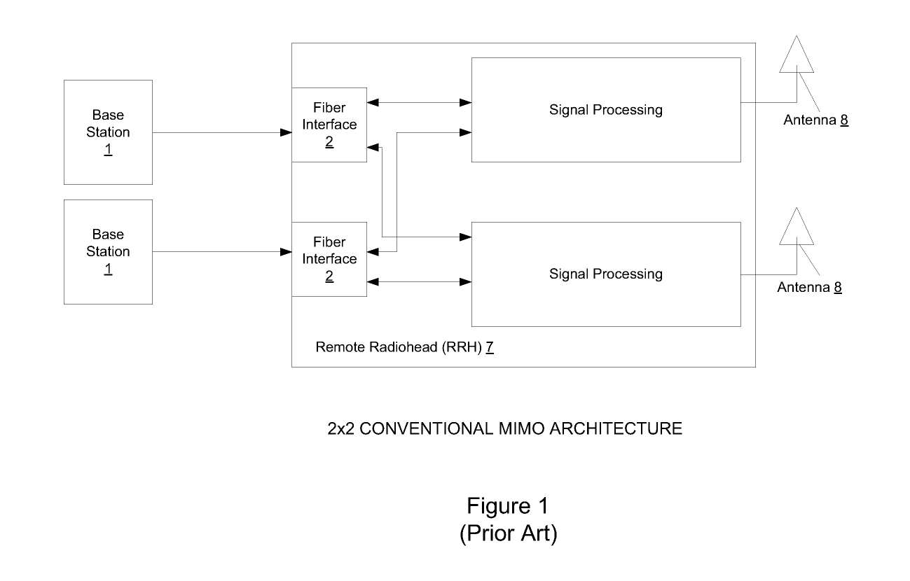

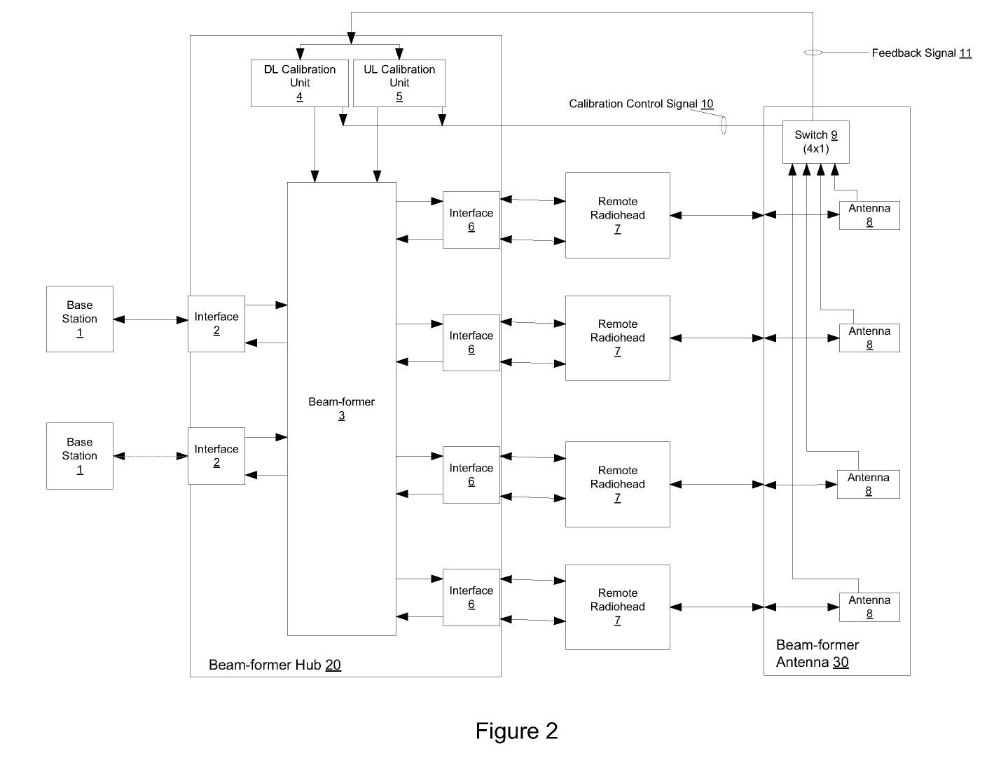

FIG. 2 is an exemplary system implementing the beam-former hub 20 in accordance with an embodiment of the invention. In particular, the system in FIG. 1 includes one or more base stations 1, a beam-former hub (BFH) 20, one or more remote radio-heads (RRH) 7, and a beam-former antenna 30 having multiple antenna elements 8. As shown in FIG. 2, the beam-former hub 20 is located seamlessly between the base stations 1 and the remote radio-heads 7, and is used in conjunction with the beam-former antenna 30 to create beam-formed radiation patterns using conventional remote radio heads 7 and base stations 1. This allows the beam-former hub system to be a highly scalable system that is compatible with various radio standards and fiber optic protocols.

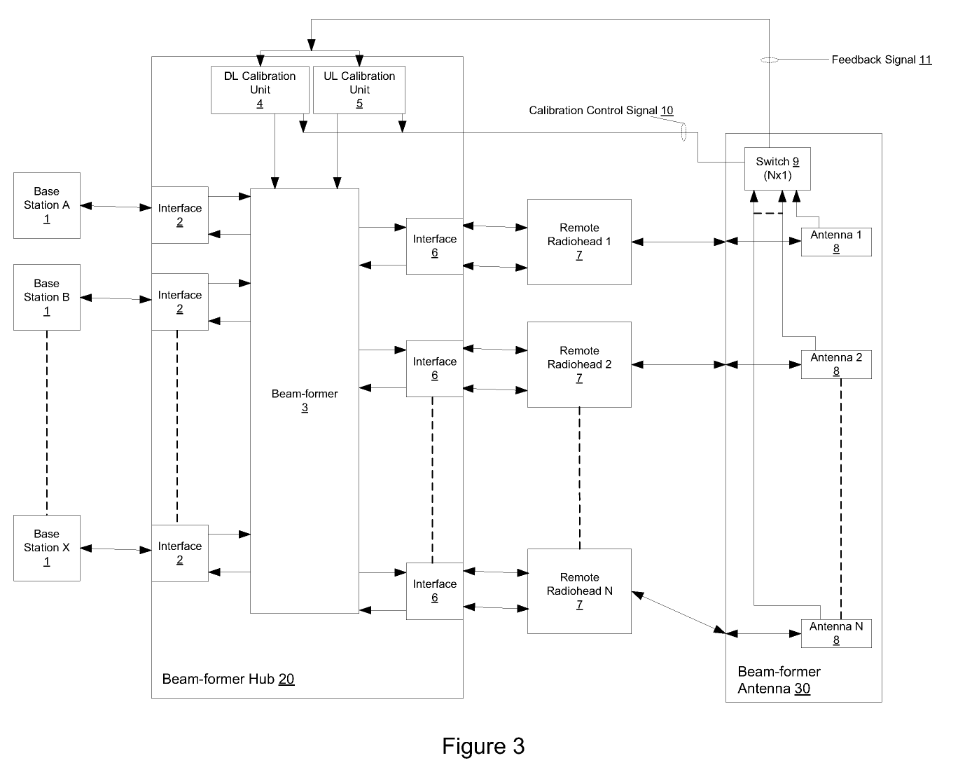

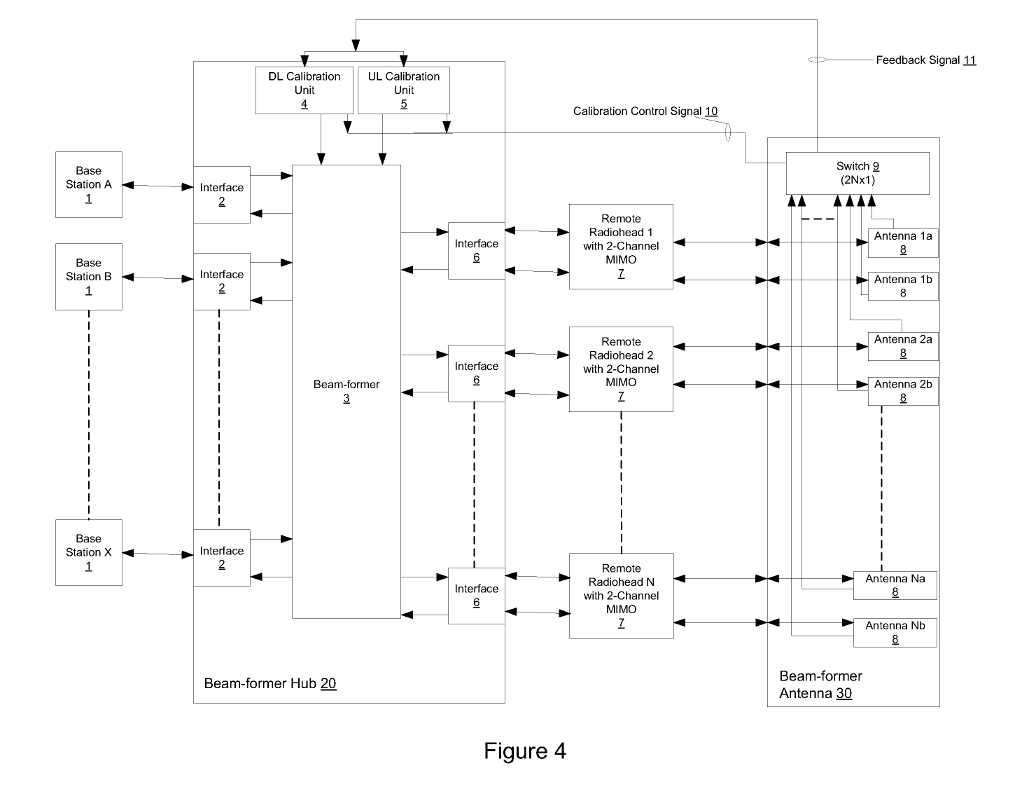

The number of base stations 1 supported by the beam-former hub system is limited only by the capacity of each of the remote radio-heads (RRH) 7 used in the system. For example, if a particular remote radio-head 7 supports a 30 MHz bandwidth, or equivalently six 5 MHz UMTS (Universal Mobile Telecommunications System) carriers, then the number of base stations 1 supported by the beam-former hub system using this single remote radio-head 7 would be six. FIG. 2 shows an exemplary beam-former hub system with two base stations 1. FIGS. 3 and 4 show exemplary beam-former hub systems having “X” base stations 1 (where X is an arbitrary number based on the requirements of the system).

The base stations 1 are connected to the beam-former hub 20 via fiber interfaces 2 in the beam-former hub 20 and are used to transmit and receive data to and from the beam-former hub 20. The remote radio-heads 7 are connected to the beam-former hub 20, via fiber interfaces 6 in the beam-former hub 20, and are also connected to the beam-former antenna 30. The remote radio-heads 7 are used to transmit and receive data to and from the beam-former hub 20, as well as to transmit and receive data to and from the beam-former antenna 30. The beam-former hub system can be used with any data protocol that is used for transmission of baseband data between the base station 1 and the remote radio-head 7. The beam-former hub system can support all existing standards including, for example, the Common Public Radio Interface (CPRI), the Open Base Station Architecture Initiative (OBSAI), and the Open Radio Interface (ORI), as well as other similar data protocol standards. In addition, the beam-former hub system can support a range of wireless radio standards including UMTS, WiMax, and LTE, as well as being used in customized applications requiring beam-forming.

The particular number of remote radio-heads 7 used in the beam-former hub system is determined by the required number of antenna elements 8 in the beam-former antenna 30 necessary to address the directionality requirements of the system and the MIMO (multiple input, multiple output) capabilities of the remote radio-heads 7 used in the system. The beam-former hub system can support MIMO functionality by either interfacing with remote radio-heads 7 that support MIMO (as shown in FIG. 4), or by interfacing with remote radio-heads 7 without MIMO capability and driving multiple sets of remote radio-heads 7—one set for each antenna polarization (e.g., for 2-channel MIMO, antenna 1a and 1b).

For example, FIG. 2 shows an exemplary beam-former hub system having four remote radio-heads 7 and a beam-former antenna 30 with four antenna elements 8. FIG. 3 shows an exemplary beam-former hub system having “N” remote radio-heads 7 and a beam-former antenna 30 with “N” antenna elements 8. FIG. 4 shows an exemplary beam-former hub system using “N” remote radio-heads 7 each with 2-channel MIMO support. This system uses “N” remote radio-heads 7 and a beam-former antenna 30 having “2N” individual antenna elements 8 (i.e., antenna 1a and 1b).

Certain radio standards such as UMTS employ SIMO (single input, multiple output) configurations requiring two receive paths and a single transmit path. The beam-former hub system can support this configuration as a special case of MIMO support. Additionally, the presence of the extra transmission paths in the beam-former hub system allows for a flexible distribution of the total transmission power available in the system across the various base stations 1.

In addition to having multiple antenna elements 8, the beam-former antenna 30 includes a switch 9 for feeding the calibration data of a specific signal path back to the beam-former hub 20 via a feedback signal 11. The beam-former hub contains a downlink (DL) calibration unit 4 and an uplink (UL) calibration unit 5 for receiving the feedback signal 11 depending on whether beam-forming is being performed during downlink (DL) data transmission or uplink (UL) data transmission. The downlink calibration unit 4 and the uplink calibration unit 5 control which particular signal path the calibration data corresponds to by controlling the switch 9, via the calibration control signal 10, so that only the calibration data for a particular signal path is transmitted via the feedback signal 11.

The DL calibration unit 4 and the UL calibration unit 5 also include dedicated circuitry used to accurately estimate the phase and frequency variations for each signal path in both DL and UL directions. These phase and frequency variations are then compensated for using the beam-former 3. The compensation for variances in the signal path is performed using the switch 9 to select the particular antenna element 8 being coupled on the feedback path from the antenna element 8 to the beam-former hub 20. This proposed method of beam-forming is not dependent on any specific wireless standard (e.g., UMTS, WiMax, LTE, etc.) or duplexing technology (e.g., FDD or TDD).

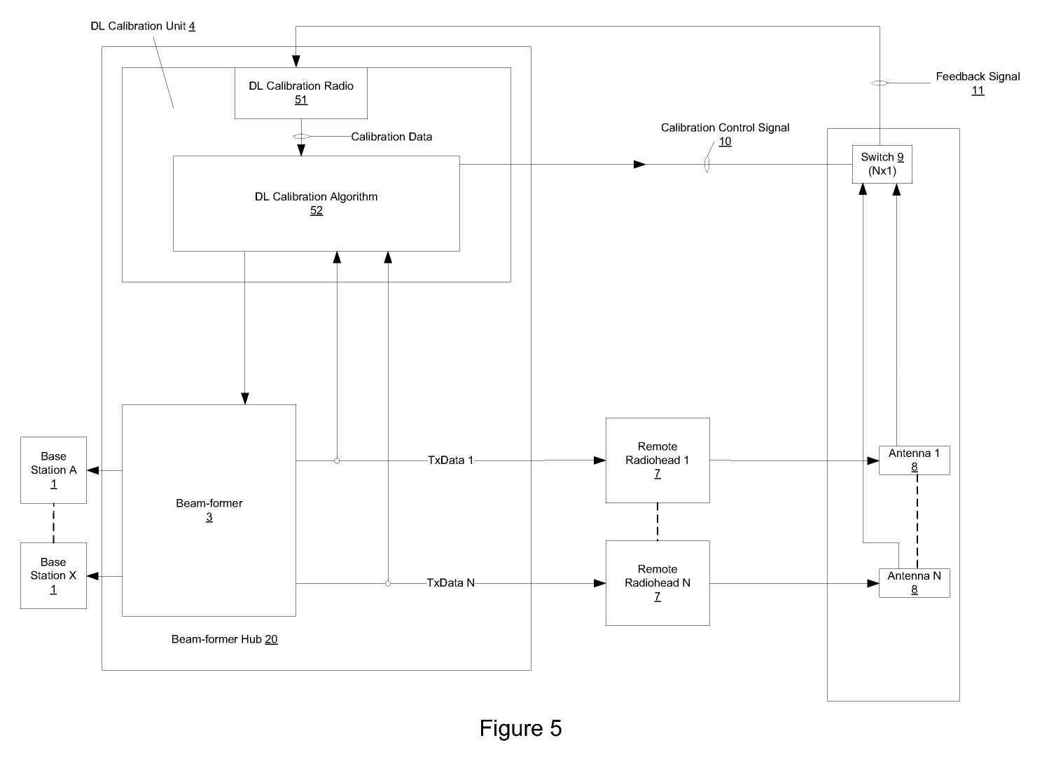

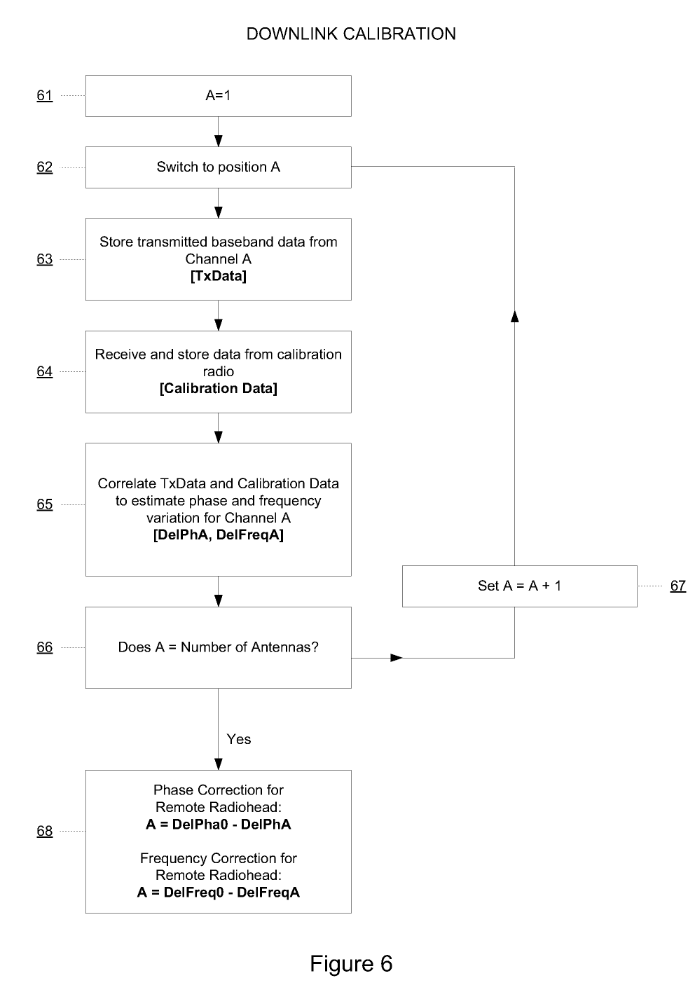

In the DL direction, the beam-former hub 20 terminates the data protocol and extracts digital data from each base station 1, performs beam-forming on the data stream, re-encapsulates the data using the same data protocol that was terminated, and transmits the data to the remote radio-head 7 for up-conversion. The beam-forming function performed during DL data transmission is discussed in detail below with regard to FIGS. 5 and 6.

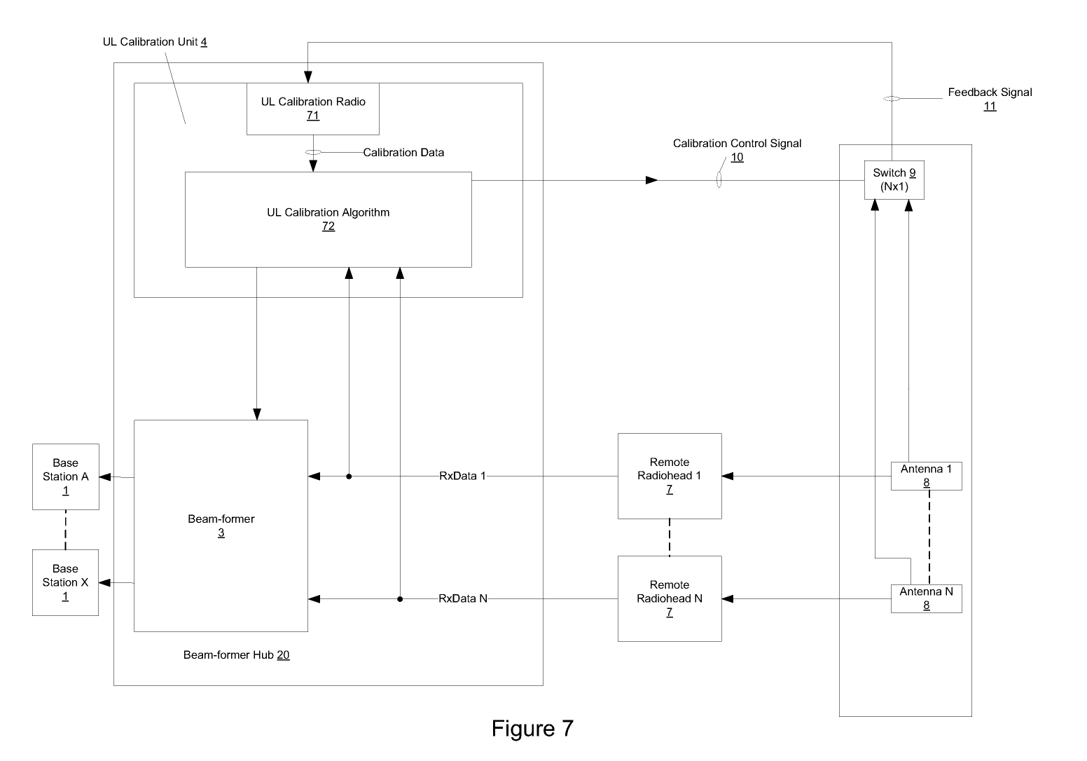

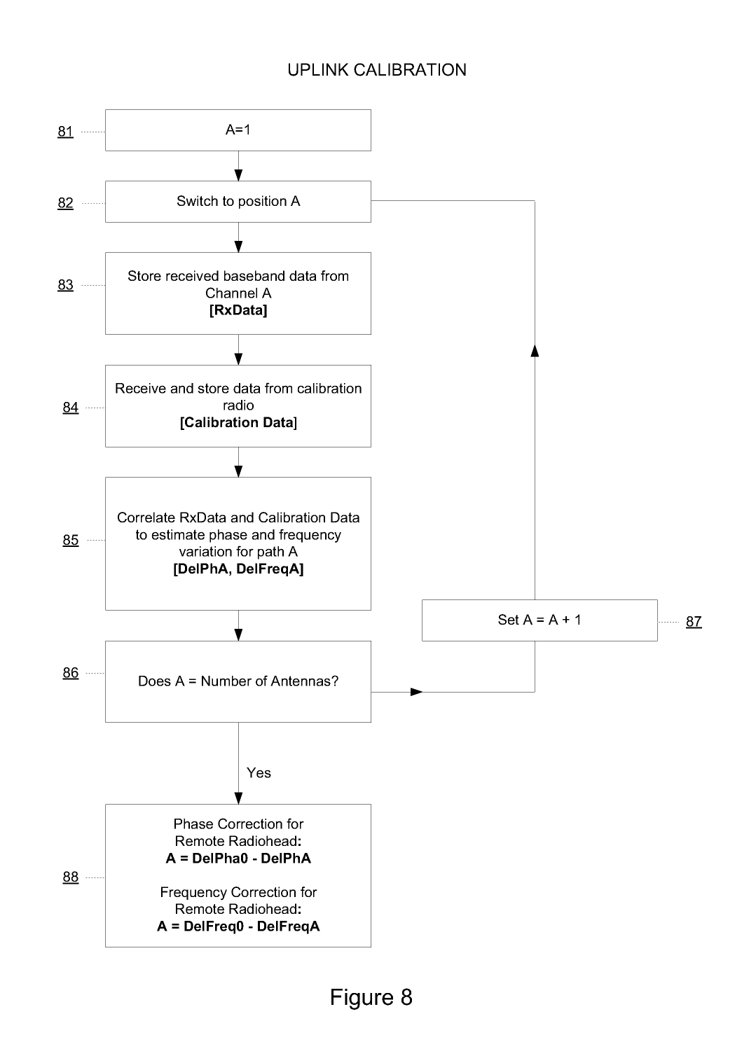

In the UL direction, the beam-former hub 20 receives down-converted data from the remote radio-head, terminates the data protocol, performs beam-forming on the data, re-encapsulates the data using the same data protocol that was terminated, and transmits the data to each base station 1. The beam-forming function performed during UL data transmission is discussed in detail below with regard to FIGS. 7 and 8.

FIG. 3 illustrates a system implementing the beam-former hub and beam-former antenna array in a wireless communication network using conventional remote radio-heads. In particular, the system in FIG. 3 includes X base stations 1 (where X is the number of base stations in the system based on the requirements of the system), a beam-former hub 20, N remote radio-heads 7 (where N is the number of remote radio-heads in the system, based on the requirements of the system), and a beam-former antenna 30 having N antenna elements 8. The specific functions of the items in FIG. 3 have been previously discussed with regard to FIG. 2 and will not be repeated.

FIG. 4 also illustrates a system implementing the beam-former hub and beam-former antenna array in a wireless communication network using conventional remote radio-heads with MIMO functionality. In particular, the system in FIG. 4 includes X base stations 1 (where X is the number of base stations in the system based on the requirements of the system), a beam-former hub 20, N 2-channel remote radio-heads 7 with MIMO functionality (where N is the number of remote radio-heads in the system, based on the requirements of the system), and a beam-former antenna 30 having 2N antenna elements 8 (i.e., one element for each channel of the 2-channel MIMO remote radio-head). Please note that although 2-channel MIMO remote radio-heads 7 are shown in FIG. 4, the beam-former system can also be implemented with P-channel MIMO remote radio-heads (where P represents the number of channels on each remote radio-head). Thus, in a beam-former hub system using P-channel remote radio-heads, the antenna array will have P×N antenna elements. The specific functions of the items in FIG. 4 have been previously discussed with regard to FIG. 2 and will not be repeated.

Irrespective of the exact configuration of the beam-former hub systems using the various parameters mentioned above, the principles of operation remain the same. The beam-former hub 20 interfaces with base stations 1 and remote radio-heads 7 using standard protocols. Therefore, no changes are necessary for either the base stations 1 or the remote radio-heads 7, which are typically designed to interface with each other anyway, to interface with the beam-former hub 20.

Beam-Forming:

Table 1, shown below, illustrates the mathematical operations involved in beam-forming. Changing the downlink (DL) and uplink (UL) weights shown in Table 1 is equivalent to changing the radiated beam patterns.

The DL and UL weights shown below refer to “corrected weights” (i.e. ideal weights for a particular pattern that have been corrected to compensate for the phase and magnitude variations in the signal processing paths of the different RRHs 7). A static weight implies a phase correction, whereas a dynamic weight (i.e., a weight that changes at each sampling interval by a known amount) implies a frequency correction. In the event that frequency compensation is needed, it would be necessary to change the weights shown below for every sample. Thus, the final weight that is applied to the data has three components:
1. a static ideal weight that represents the ideal phase shift needed for the desired pattern. This weight is typically programmed using software;
2. a static weight correction that represents the phase correction needed to compensate for phase variations in the signal processing paths; and
3. a dynamic weight correction that represents the frequency correction needed to compensate for phase variations in the signal processing paths.

TABLE 1
Mathematical Operations of Beam-Forming

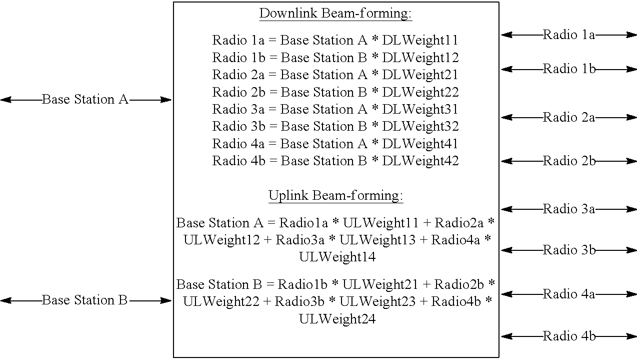

Downlink Data Transmission

FIG. 5 illustrates the beam-former hub system with particular focus on the elements necessary for performing beam-forming in downlink data transmission. In FIG. 5, the fiber interface (e.g., interface 2 as shown in FIG. 2) of the beam-former hub 20 terminates the data protocol of data transmitted from the base station 1, extracts complex data samples from the data, and stores all the relevant control fields. As shown in Table 1, the complex data samples from each base station 1 are multiplied with N complex weights, where N is equal to the number of remote radio-heads 7. The weighted data samples created as a result of the beam-forming operation are re-encapsulated using the same data protocol that was terminated by the fiber interface, and transmitted to the remote radio-heads 7. The stored control fields of the link between the base station 1 and the beam-former hub 20 are then transmitted to the remote radio-heads 7 via the link between the beam-former hub 20 and the remote radio-heads 7. The weighted data is then combined inside each remote radio-head 7.

FIG. 6 illustrates a flowchart showing a method of beam-forming in downlink data transmission. As shown in FIG. 6, phase and frequency corrections are computed for all remote radio-heads 7 relative to a reference remote radio-head 7 (e.g., remote radio-head 1 7) (Step 61). The algorithm sequentially estimates the phase and frequency offset introduced by the downstream signal path, including the remote radio-head 7 processing path. For an “N” remote radio-head 7 system as shown in FIG. 5, at time t₁, the Nx1 switch is controlled using a calibration control signal 10 to close the path from antenna 1 8 to the feedback signal 11 feeding the beam-former hub 20 (Step 62). In parallel, a copy of the signal sent on the forward path to antenna 1 8 is stored in the beam-former hub 20 (Step 63). The calibration data is received by the DL calibration radio 51 via the feedback signal 11 (Step 64). Since this feedback signal 11 is an analogue RF signal, it is first down-converted to digital baseband using conventional radio design. Once the down-converted baseband samples are available, a time domain DL calibration algorithm 52 is applied to correlate the data received from the feedback path to the stored forward path data that was transmitted (Step 65). The process is then sequentially repeated for the number of remote radio-heads 7 in the system (Steps 66 and 67). Phase and frequency corrections are applied by the beam-former 3 to the data from all the remote radio-heads 7 other than the reference remote radio-head 1 7, and these corrections amount to equalizing the phase and frequency variations for all remote radio-heads 7 in the DL direction (Step 68).

Uplink Data Transmission

FIG. 7 illustrates the beam-former hub system with particular focus on the elements necessary for performing beam-forming in uplink data transmission. In FIG. 7, the fiber interface (e.g., interface 6 as shown in FIG. 2) of the of the beam-former hub 20 terminates the data protocol of data transmitted from the remote radio-head 7, extracts the complex data samples from the data, and stores all the relevant control fields. As shown in Table 1, the complex data samples from each remote radio-head 7 intended for a single base station 1 are multiplied with N complex weights and combined, where N is equal to the number of remote radio-heads 7. However, unlike in the DL direction, the weighted samples are combined in the beam-former hub 20. The weighted-sum data samples are re-encapsulated using the same data protocol that was terminated by the fiber interface and transmitted to the base station 1. The stored control fields of the link between the remote radio-head 7 and the beam-former hub 20 are then transmitted to the base stations 1 via the link between the beam-former hub 20 and the base stations 1.

FIG. 8 illustrates a flowchart showing a method of beam-forming in uplink data transmission. As shown in FIG. 8, phase and frequency corrections are computed for all remote radio-heads 7 relative to a reference remote radio-head 7 (e.g., remote radio-head 1 7) (Step 81). The algorithm sequentially estimates the phase and frequency offset introduced by the uplink signal path for each remote radio-head 7. For an “N” remote radio-head 7 system as shown in FIG. 7, at time t₁, the Nx1 switch is controlled using a calibration control signal 10 to close the signal path from antenna element 1 8 to the feedback signal 11 feeding the beam-former hub 20 (Step 82). Since this feedback signal 11 is an analogue RF signal, it is first down-converted to digital baseband using conventional radio design. In parallel, a copy of the baseband signal received from remote radio-head 1 7 is stored in the beam-former hub 20 (Step 83). The calibration data is received by the UL calibration radio 71 via the feedback signal 11 (Step 84). Once the down-converted baseband samples are available from the uplink calibration radio 71, a time domain correlation algorithm is applied to correlate the data received from the calibration path to the data received from the uplink path (Step 85). The process is then sequentially repeated for the number of remote radio-heads 7 in the system (Steps 86 and 87).

Phase and frequency corrections are applied to all remote radio-heads 7 other than the reference remote radio-head 1 7, and these corrections amount to equalizing the phase and frequency variations for all remote radio-heads 7 in the UL direction (Step 88).

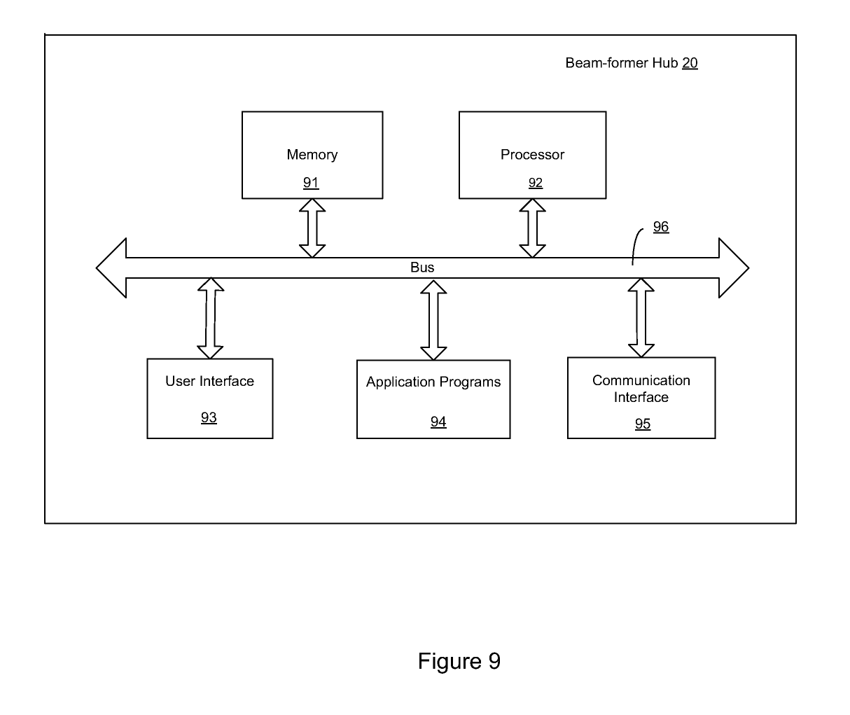

FIG. 9 is a more detailed description of the beam-former hub apparatus 20 for performing the uplink and downlink beam-forming method, as previously described with reference to FIGS. 6 and 8 in accordance with an embodiment of the invention. In FIG. 9, the beam-former hub apparatus 20 includes a memory 91, a processor 92, user interface 93, application programs 94, communication interface 95, and bus 96.

The memory 91 can be computer-readable storage medium used to store executable instructions, or computer program thereon. The memory 91 may include a read-only memory (ROM), random access memory (RAM), programmable read-only memory (PROM), erasable programmable read-only memory (EPROM), a smart card, a subscriber identity module (SIM), or any other medium from which a computing device can read executable instructions or a computer program. The term “computer program” is intended to encompass an executable program that exists permanently or temporarily on any computer-readable storage medium as described above.

The computer program is also intended to include an algorithm that includes executable instructions stored in the memory 91 that are executable by one or more processors 92, which may be facilitated by one or more of the application programs 94. The application programs 94 may also include, but are not limited to, an operating system or any special computer program that manages the relationship between application software and any suitable variety of hardware that helps to make-up a computer system or computing environment of the beam-former hub apparatus 20. General communication between the components in the beam-former hub apparatus 20 is provided via the bus 96. The beam-forming algorithm as described with reference to FIGS. 6 and 8, can be stored, for example, in the memory 91 of the beam-former hub apparatus 20.

The user interface 93 allows for interaction between a user and the beam-former hub apparatus 20. The user interface 93 may include a keypad, a keyboard, microphone, and/or speakers. The communication interface 95 provides for two-way data communications from the beam-former hub apparatus 20. By way of example, the communication interface 95 may be a digital subscriber line (DSL) card, an integrated services digital network (ISDN) card, a cable base station, or a telephone base station to provide a data communication connection to a corresponding type of telephone line. As another example, communication interface 95 may be a local area network (LAN) card (e.g., for Ethernet or an Asynchronous Transfer Model (ATM) network) to provide a data communication connection to a compatible LAN.

Further, the communication interface 95 may also include peripheral interface devices, such as a Universal Serial Bus (USB) interface, a Personal Computer Memory Card International Association (PCMCIA) interface, and the like. The communication interface 95 also allows the exchange of information across one or more wireless communication networks. Such networks may include cellular or short-range, such as IEEE 802.11 wireless local area networks (WLANS). And, the exchange of information may involve the transmission of radio frequency (RF) signals through an antenna (not shown).

From the description provided herein, those skilled in the art are readily able to combine software created as described with the appropriate general purpose or special purpose computer hardware for carrying out the features of the invention.

Additionally, it should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

What is claimed is:

1. A method for performing beam-forming in a wireless communication network, the method comprising:
receiving data having a particular data protocol;
storing the received data by terminating the particular data protocol, extracting data samples, and storing relevant control fields;
obtaining calibration data for a signal path;
estimating a phase variation and a frequency variation introduced by the signal path by correlating the stored data and the calibration data;
determining a weight based on the estimated phase variation and the estimated frequency variation;
weighting the extracted data samples using the determined weight;
re-encapsulating the weighted data samples using the particular data protocol to create weighted data; and
transmitting the weighted data using the stored control fields so that the phase variation and the frequency variation are equalized.

2. The method for performing beam-forming of claim 1, wherein the determined weight includes a static ideal weight component representing an ideal phase shift necessary for a desired beam-forming pattern.

3. The method for performing beam-forming of claim 2, wherein the determined weight includes a static weight correction component representing a phase correction.

4. The method for performing beam-forming of claim 2, wherein the determined weight includes a dynamic weight correction component representing a frequency correction.

5. A non-transitory computer-readable recording medium on which a program for performing beam-forming in a wireless communication network is recorded, the program causing a computer to execute a method comprising:
receiving data having a particular data protocol;
storing the received data by terminating the particular data protocol, extracting data samples, and storing relevant control fields;
obtaining calibration data for a signal path;
estimating a phase variation and a frequency variation introduced by the signal path by correlating the stored data and the calibration data;
determining a weight based on the estimated phase variation and the estimated frequency variation;
weighting the extracted data samples using the determined weight;
re-encapsulating the weighted data samples using the particular data protocol to create weighted data; and
transmitting the weighted data using the stored control fields so that the phase variation and the frequency variation are equalized.

6. The non-transitory computer-readable recording medium of claim 5, wherein the determined weight includes a static ideal weight component representing an ideal phase shift necessary for a desired beam-forming pattern.

7. The non-transitory computer-readable recording medium of claim 6, wherein the determined weight includes a static weight correction component representing a phase correction.

8. The non-transitory computer-readable recording medium of claim 6, wherein the determined weight includes a dynamic weight correction component representing a frequency correction.

9. A beam-former hub apparatus for use with an antenna array including a plurality of antennas and a switch, the beam-former hub apparatus comprising:
a plurality of interfaces for transmitting and receiving data having a particular data protocol;
a calibration unit for (i) controlling the switch to transmit calibration data for a particular signal path, (ii) receiving, from the antenna array, calibration data for the particular signal path, and (iii) correlating the calibration data with the data to obtain correlation data; and
a beam-forming unit for performing beam-forming by applying a weight to the data based on the correlation to create weighted data.

10. The beam-former hub apparatus of claim 9, wherein the calibration unit includes a downlink calibration unit for receiving the calibration data for downlink data transmission, and an uplink calibration unit for receiving the calibration data for uplink data transmission.

11. The beam-former hub apparatus of claim 9, wherein the plurality of interfaces also store the data by terminating the particular data protocol, extracting data samples, and storing relevant control fields.

12. A communication system comprising:
a plurality of base stations for transmitting and receiving data;
a plurality of remote radio-heads for transmitting and receiving data;
and an antenna array, including a switch, for transmitting and receiving data; and
a beam-former hub apparatus for performing beam-forming in data transmission, the beam-former hub apparatus comprising:
a plurality of interfaces for transmitting and receiving data having a particular data protocol;
a calibration unit for (i) controlling the switch to transmit calibration data for a particular signal path, (ii) receiving, from the antenna array, calibration data for the particular signal path, and (iii) correlating the calibration data with the data to obtain correlation data; and
a beam-forming unit for performing beam-forming by applying a weight to the data based on the correlation to create weighted data.

13. The communication system of claim 12, wherein when performing beam-forming in the uplink direction, the weighted data is combined in the beam-former hub apparatus.

14. The communication system of claim 12, wherein when performing beam-forming in the downlink direction, the weighted data is combined in each of the plurality of remote radio-heads.

15. The communication system of claim 12, wherein at least one of the plurality of remote radio-heads has MIMO (multiple input, multiple output) functionality.

16. The communication system of claim 12, wherein the weight includes a static ideal weight component representing an ideal phase shift necessary for a desired beam-forming pattern.

17. The communication system of claim 16, wherein the weight further includes a static weight correction component representing a phase correction.

18. The communication system of claim 16, wherein the weight further includes a dynamic weight correction component representing a frequency correction.

19. The communication system of claim 12, wherein the switch sends a feedback signal, corresponding to the particular signal path, to the beam-former hub apparatus.
